(19) United States
(12) Patent Application Publication
(10) Pub. No.: US 2006/0147073 A1
(43) Pub. Date: Jul. 6, 2006

(54) Mirror component embedded with an audio-function module

(76) Inventor: Yi Chun Chen, Taipei (TW)

Correspondence Address: THE MAXHAM FIRM, 750 "B" STREET, SUITE 3100, SAN DIEGO, CA, 92101, US

(21) Appl. No.: 11/029,684

(22) Filed: Jan. 4, 2005

(51) Int. Cl. H04R 9/06

(52) U.S. Cl. 381/333

(57) ABSTRACT

The present invention discloses a mirror component combining with an audio-function and/or video-function module. The mirror component comprises a mirror carrier. A mirror is configured in the mirror carrier. An audio-function and/or video-function module is configured in the mirror carrier. A control interface is electrically connected with the audio-function and/or video-function module.

### FIELD OF THE INVENTION

The present invention relates to a mirror component, and more specially, to a mirror component embedded with an audio-function module for receiving frequency modulation broadcasting signal or amplitude modulation broadcasting signal.

### DESCRIPTION OF RELATED ART

Mirror surfaces installed in bath and shower rooms are subject to moisture condensation on the reflecting surface which blurs and distorts the reflected image on the mirror face. It is known that warming a mirror surface to a temperature of four degrees Fahrenheit or greater above the ambient air temperature will prevent the formation of moisture on the mirror surface. A review of the prior art reveals many designs of heating elements that can be affixed to the rear surface of mirrors to provide the necessary temperature to prevent moisture condensation, or fogging.

Furthermore, mirror installed in bath and shower rooms fails to disclose others function except for reflecting image on the mirror face.

In view of the aforesaid problems of the prior art, it is an object of this invention to provide a new type mirror component.

### SUMMARY OF THE INVENTION

The object of the present invention is to disclose a mirror component embedded with an audio-function module for receiving frequency modulation broadcasting signal or amplitude modulation broadcasting signal.

The present invention discloses a mirror component combining with audio-function module. The mirror component comprises a mirror carrier or frame. A mirror is configured in the mirror carrier. An audio-function and/or video-function module is configured in the mirror carrier. A control interface is optionally electrically connected with the audio-function and/or video-function module.

These and other features of the present invention and advantages will be more clearly understood from the drawings and description of a preferred embodiment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a diagram of a mirror component according to the present invention.

FIG. 2 illustrates a diagram of an audio-function and/or video-function module and a control interface according to the present invention.

### DETAILED DESCRIPTION OF THE PREFERRED EMBODIMENTS

In the following description, numerous specific details are provided, such as the identification of various system components, to provide a thorough understanding of embodiments of the invention. However, one skilled in the art will recognize that the invention can be practiced without one or more of the specific details, or with other methods, components, materials, etc. In still other instances, well-known structures, materials, or operations are not shown or described in detail to avoid obscuring aspects of various embodiments of the invention.

According to the present invention, an audio-function and/or video-function module is embedded in a mirror component that may be adaptable for a bathroom or toilet mirror.

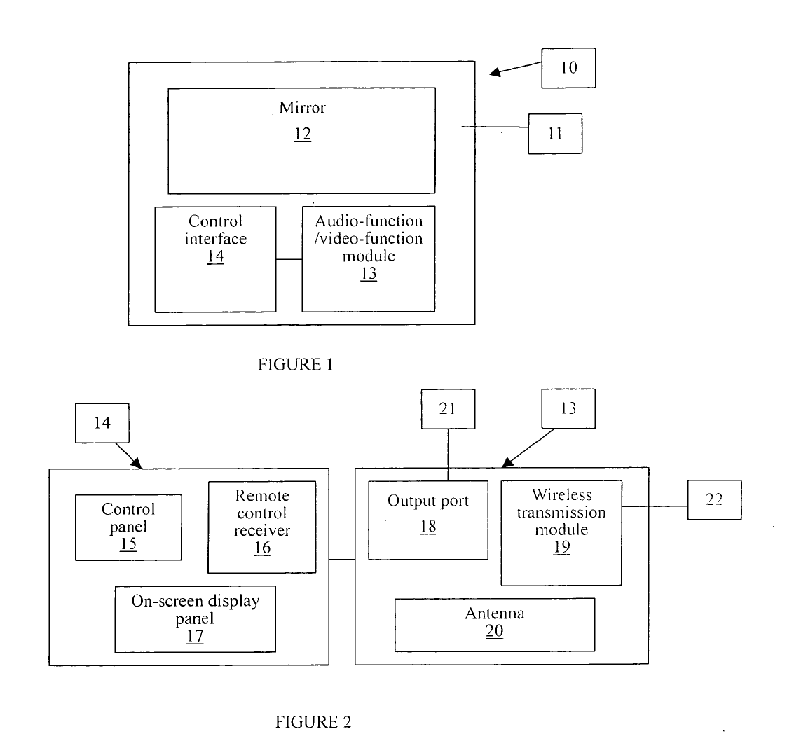

As shown in FIG. 1, a mirror component 10 comprises a mirror carrier or frame 11. A mirror 12 is configured and adapted to the mirror carrier 11. An audio-function and/or video-function module 13 is configured in the mirror carrier 11. The mirror component may optically include a control interface 14 electrically connecting with the audio-function module and/or video-function module 13.

The audio-function module 13 includes an audio-function device, such as a radio for receiving frequency modulation broadcasting signal or amplitude modulation broadcasting signal.

As shown in FIG. 2, the control interface 14 may include a control panel 15, a remote control receiver 16 or an on-screen display (OSD) panel 17.

Furthermore, the audio-function module 13 may include an output port 18. The output port 18 may connect with an earphone or a speaker 21. For example, the speaker 21 is a water proof speaker. The earphone is outwardly connected the output port. The speaker may be located inside or outside of the mirror component 10. The output port 18 is, for example an USB port.

The audio-function module 13 may include a wireless transmission module 19. The wireless transmission module 19 can receive and store wireless transmission data transmitted from an outside signal source such as a media center 22 or the like. The communication specifications and protocol between the wireless transmission module 19 and the media center are, for example 802.11 compatible format or blue tooth compatible format, etc.

The audio-function module 13 may include a radio, MP3 player, CD player. The audio-function module may include an antenna 20. The video-function module may include a VCD player.

While the invention is described and illustrated here in the context of a limited number of embodiments, the invention may be embodied in many forms without departing from the spirit of the essential characteristics of the invention. The illustrated and described embodiments are therefore to be considered in all respects as illustrative and not restrictive. Thus, the scope of the invention is indicated by the appended claims rather than by the foregoing description, and all changes which come within the meaning and range of equivalency of the claims are intended to be embraced therein.

What is claimed is:

1. A mirror component with an audio-function module, comprising;
a mirror carrier;
a mirror configured in said mirror carrier; and
an audio-function and/or video-function module configured in said mirror carrier.

2. The mirror component according to claim 1, wherein said mirror component further includes a control interface electrically connecting with said audio-function and/or video-function module.

3. The mirror component according to claim 2, wherein said control interface includes a control panel.

4. The mirror component according to claim 3, wherein said control interface includes a remote control receiver.

5. The mirror component according to claim 4, wherein said control interface includes an on-screen display (OSD) panel.

6. The mirror component according to claim 1, wherein said audio-function module includes an audio-function device, wherein said audio-function device can receive frequency modulation broadcasting signal or amplitude modulation broadcasting signal.

7. The mirror component according to claim 1, wherein said audio-function module includes an output port, wherein said output port is connected with an earphone or a speaker.

8. The mirror component according to claim 7, wherein said speaker is a water proof speaker.

9. The mirror component according to claim 7, wherein said output port is an USB port.

10. The mirror component according to claim 1, wherein said audio-function module includes a wireless transmission module, wherein said wireless transmission module can receive and store wireless transmission data transmitted from a media center.

11. The mirror component according to claim 1, wherein said audio-function module includes a radio, MP3 player, CD player.

12. The mirror component according to claim 1, wherein said audio-function module includes an antenna.

13. The mirror component according to claim 1, wherein said video-function module includes a VCD player.

14. A mirror component with an audio-function module, comprising;
a mirror carrier;
a mirror configured in said mirror carrier; an audio-function and/or video-function module configured in said mirror carrier; and
a control interface electrically connecting with said audio-function and/or video-function module.

15. The mirror component according to claim 14, wherein said control interface includes a control panel.

16. The mirror component according to claim 15, wherein said control interface includes a remote control receiver.

17. The mirror component according to claim 16, wherein said control interface includes an on-screen display (OSD) panel.

18. The mirror component according to claim 14, wherein said audio-function module includes an audio-function device, wherein said audio-function device can receive frequency modulation broadcasting signal or amplitude modulation broadcasting signal.

19. The mirror component according to claim 14, wherein said audio-function module includes an output port, wherein said output port is connected with an earphone or a speaker.

20. The mirror component according to claim 19, wherein said speaker is a water proof speaker.

21. The mirror component according to claim 19, wherein said output port is an USB port.

22. The mirror component according to claim 14, wherein said audio-function module includes a wireless transmission module, wherein said wireless transmission module can receive and store wireless transmission data transmitted from a media center.

23. The mirror component according to claim 14, wherein said audio-function module includes a radio, MP3 player, CD player.

24. The mirror component according to claim 14, wherein said video-function module includes a VCD player.
